(19) United States
(12) Patent Application Publication
(10) Pub. No.: US 2014/0081785 A1
(43) Pub. Date: Mar. 20, 2014

(54) TELEMATIC PAYMENT CARD

(71) Applicant: Manuel Janssen Valadas Preto, S.J.Estoril (PT)

(72) Inventor: Manuel Janssen Valadas Preto, S.J.Estoril (PT)

(21) Appl. No.: 14/116,080

(22) PCT Filed: May 7, 2012
(86) PCT No.: PCT/IB2012/052266

§ 371 Date: Nov. 6, 2013

(30) Foreign Application Priority Data
May 6, 2011 (PT) 105677

(51) Int. Cl. G06Q 20/34

(52) U.S. Cl. CPC G06Q 20/341; G06Q 20/352
USPC 705/21; 705/41

(57) ABSTRACT

Telematic Payment Card for use remotely with a Central Control & Processing Unit, for paying goods and services using mobile network, and transferring money between accounts remotely, enabling a payment card with monitor and keyboard to communicate banking and financial data remotely to financial institutions and payment networks via said central unit.

It is able to perform Person-to-Person (P2P) payments between card holders, Person-to-Merchant (P2M), Person-to-Machine (P2Mx) or between a card holder and a bank account. It also enables payments as a normal payment card (debit, credit, pre-paid etc) using a POS (Point Of Sale) terminal at a merchant.

An embodiment comprises a battery (201), a security chip (202), processor module (203), memory module (204), sound emitter (205), near filed communications (206), mobile communication module (207), connection or inductive power port (208), input means (209), indicator means (210), display/touch screen (211), antennas or data connections (212, 213).

### TECHNICAL FIELD

The present invention relates to a Telematic Payment Card, in the domain of Banking Payment systems or, more specifically, Payment Cards, but also has a component of Mobile Data Communications.

### SUMMARY

One object of this invention is a Telematic Payment Card device that, when used remotely in conjunction with a Central Control & Processing Unit, can be used for accessing a bank account, or for paying goods and services using the mobile network as it has the capability of transferring money between accounts remotely, enabling a payment card with a monitor, a keyboard and the technology to communicate banking and financial data remotely via a central control & processing unit, between financial institutions, banks, and/or payment networks.

As one of its core functions, it has the ability to perform Person-to-Person (P2P) payments between 2 card holders (something not possible at present), Person-to-Merchant (P2M), Person-to-Machine (P2Mx) or between a card holder and a bank account. These functionalities can be used any-time in any-place in near-real-time by combining card secure technology, mobile technology and an input/output interface. Except for P2M, the parties do not need to be physically present.

It also enables payments as a normal payment card (debit, credit, pre-paid etc) using a POS (Point Of Sale) terminal at a merchant, enabling the card to offer the same services as actual payment cards.

In addition, the Telematic Payment Card permits the access and management of a bank account linked to the card, which is uniquely and securely identified by means of payment technology by the Central Control & Processing Unit that is in communication with financial institutions and payment networks. These entities are able to communicate with the Telematic Payment Card, and vice-versa, so that information and communications can be exchanged between them.

This invention uses a combination of technologies from several domains, among which:

Payment cards—the Telematic Payment Card uses existing technology from secure payment cards, as is the chip EMV (Europay Mastercard Visa) that enables the unique and secure identification of the card-holder. It safely stores a password (requested to authorise payments) and non-secure bank data that identifies the destination or origin of payments (e.g. bank account+bank id etc, such as used in IBAN for international bank transfers)

Mobile communications—the Telematic Payment Card communicates authentication data, transaction data (such as the amount to be paid), bank account IDs and receives financial information such as payments received and account balances, in the format of basic data streams using the existing mobile network. For that, each Telematic Payment Card has embedded basic data mobile modules, such as an antenna, a SIM (Subscriber Identity Module) card to uniquely identify the Telematic Payment Card in the mobile network (which can eventually be shared with the chip EMV), and a data processing module

Battery—although the Telematic Payment Card can, in some cases work without electric power (so that the card-holder can still make a payment in specific cases with the help of an external device), a battery is needed to take full advantage of the mobility of the Telematic Payment Card. This battery is preferably slim, flexible with high-capacity, but the exact product depends on the evolution of the State of the Art and the availability of advanced solutions at each moment in time

Touch-screen—the card-holder uses a touch-screen as way for inputting payment data (amount and payee), security data (password or fingertip reading, if needed), and for navigation through the menus, read messages or configuring the Telematic Payment Card. The exact product depends on the evolution of the State of the Art and the availability of advanced solutions at each moment in time

### BACKGROUND ART

At present there is no product in the form of a Payment Card, that can allow the payment between two individuals (called P2P payment). The only alternatives are: cash (expensive method), cheques (outdated and very expensive as they involve paper handling and are subject to fraud), bank transfers (not convenient as they need to be performed via a specific terminal), computers or mobile phones (which have failed to be accepted by the public due to lack of trust and cumbersome handling), and other likewise expensive or inconvenient solutions and technologies that only work well in specific conditions or with niche users.

In fact, innovation and advanced solutions in commercial banking have been hindered by the conservative approach and attitude to risk (the unknown) when it comes to personal savings and finances. The reality is that people are much more conservative when it comes to their life savings than they would otherwise be with other products where the loss would be restricted to mostly the product and service price plus some eventual collateral but restricted losses.

Several trials of implementing payment solutions in mobile terminals have been tried for the last 15 years. Most have failed and only niche solutions are being adopted by a minority of the public. Some cases of success are those in developing countries where more people have mobile terminals than bank accounts. But the reality is that needs in the developed world are more complex.

In payments, another niche solution with wide success is internet payment (such as PayPal), but, again, they offer a specific solution to a specific audience.

Payment Cards in several shapes such as Debit, Credit, Pre-paid, Deferred Debit, Store, etc have been experiencing a huge success, and their acceptance is almost universal. But innovation in Payment Cards has been almost non-existing since they first appeared with Dinners around 1950, with the exception of attached services (not really related with technique) and security add-ons like the chip EMV or encryption algorithms.

Both governments, central banks, commercial banks and other financial institutions and even the public and merchants want a more cashless society, but to succeed, this cashless society needs to be seamless, convenient, cheap and risk free. Cash is a very convenient paper payment but it is also inefficient, expensive (all the cash that is circulating outside the banking environment, is in fact almost worthless as cannot be used to produce more wealth), is untraceable, supports the black economy and corruption, is more risky (as once is stolen there is almost no way of recovering it), and the list goes on. The fact is that most players would prefer an economy with less paper cash.

Banks are constantly looking for products and solutions that are specific bank products (and not a device, like a mobile phone or a computer, that they have to share with other industries and companies, and thus is less secure and simple) and that allows an exclusive and continuous communication channel to their customers. This invention increases the efficiency of their customer and product management processes.

### DISCLOSURE OF THE INVENTION

One important reason why most inventions in payments fail is the lack of convenience, and customers' attitude to risk while adopting something new and unproven. Inventors normally expect people to adopt extremely clever and ingenious payment products but forget that sometimes people have a completely different attitude towards anything that touches their life savings and their cash. This Telematic Payment Card invention uses the development of technology and the knowledge of people's attitudes above referred to minimize the apparent impact of innovation and thus reducing the perceived risk of adopting a new technology, while in fact providing them with a gradual, yet very powerful tool, to make payments and to manage their whole relationship with their finances and their bank. The entry step for a new Telematic Payment Card user is to make payments in merchants with a POS, just as he does now with his normal card.

Today, technology has developed enough to enable the present invention to be implemented in such a way that a card-holder can see the Telematic Payment Card of the present invention almost like an existing Payment Card, with relation to size, look&feel, handling etc, when, in fact, it has many more features enabled by the embedded technology.

The present State of the Art in the several domains that are included in the present invention (like, but not limited to, slim and flexible Batteries and Touch-screens) allows the implementation of a Telematic Payment Card that can be as slim and flexible as a common actual Credit or Debit Card. The basic usage of this card is as similar to an actual card as possible to reduce the perception of nouveaux and thus risk.

In addition to enable P2P payments on the move (any-time in any-place in near-real-time) even without the physical presence of payee cards, the embedded technology of the Telematic Payment Card and the fact that is connected to a Central Control & Processing Unit via a data link (mobile, internet or dedicated) allows many other features to be offered to the card-holder: the card-holder can send or receive information from the bank linked to the Telematic Payment Card account (such as, but not limited to movements in the bank account, new cards issued, security information etc) or from processing entities (such as, but not limited to payments received or completed, fraud detection etc) or any other entity that can link to the Central Control & Processing Unit. This way, the card-holder of a Telematic Payment Card can have a constant update of his bank account status in his card. This solves another major issue for clients of financial institutions by enabling them to have full security and control of their finances. Banks also have in this way a very efficient communication tool with their clients.

This type of services with real-time financial products control, with information automatically generated and sent by the financial institution when the event occurs, are currently not offered by any bank in the world, except in limited services services via phone-banking or SMS but which forces the client to have a phone with often specific software applications installed in devices shared by other companies and industries, and in any case the request must be originated by the user.

In addition, this Telematic Payment Card can be offered to people without a bank account, offering them the possibility to upload pre-paid cash in the Central Control & Processing Unit. This enables people that cannot or do not want to have a bank account, the possibility to make electronic payments.

The following groups benefit from this invention:

Consumers:
Have the need to make personal payments (P2P) using cashless plastic money as they now pay to Merchants (P2M)
They expect more innovation from banks; most research indicates that clients criticise their banks for being too conservative
One of the most important concerns for consumers, regarding payments and bank account management, is control and security of their finances and transactions. Telematic Payment Card of the present invention allows them a very high level of control, not only of their transactions but also their bank accounts
As consumers become more mobile, they need to make payments and control their finances any-time in any-place in near-real-time
Small merchants are able to accept plastic cards using their own personal bank account or Telematic Payment Card and without the need to get a POS

Financial Institutions:
They seek ways of becoming innovative but without increasing their risk, and without imposing more complexity to their customers (most commercial banks are inclusive, and serve all types of social and educational levels)
They need to gain control of payments solutions, as some new inventions in the market bypass banks (such as mobile and internet payments)
Banks seek new ways of increasing automatisation of bank account management to reduce costs
They also seek ways of increasing the percentage of electronic payments as this increases transactions and increases the average balance of bank accounts (money only leaves the account when a purchase is made and not when the cash is withdrawn from an ATM of cashier, the same for receivables)

Governments and Central Banks:
Central banks want to reduce paper money in circulation as this brings inefficiency to the system. Cash that is loaded in a ATM and from there to a wallet and to a cash register, and until is deposited back in a bank, is out of circulation and cannot be used to produce wealth
International payment schemes are controlled by American companies. Other countries and the EU want a card scheme or a payment network independent from a country. This innovation, after maturing, could bring more independence to card schemes.
Governments want more technological breakthroughs, specially those that increase economic efficiency and are directed at the overall population
Governments and economic players want ways of increasing the international cross-border mobility in payments. This invention is designed as to have the least international limitations, as it uses solutions and interfaces used internationally

Telecom Companies:
Telecom operators seek new revenue models to help recoup their investments, specially the one made for their data networking. The Telematic Payment Card would use their data links often but for very limited amount of data. By taking very little capacity of the bandwidth, links can still be used for other applications
Telecom operators want a foot in the door of payments. They have often tried to launch mobile payment systems of their own but with limited success until now

The Telematic Payment Card is a Payment Card with telematic capabilities enabling the communication of transactional and banking data between cards and to/from a Central Control & Processing Unit.

An embodiment of the Telematic Payment Card may have at least the following main blocks:

1. A card looking shell with, in the front side:
1.1. A touch-screen for the input of commands and output of information
1.2. Buttons for power on/off, and for standard commands that are dependent on the menu in the screen
1.3. Some LEDs for visual control of card status, which could be:
   1.3.1. Battery status
   1.3.2. Mobile network availability
   1.3.3. Presence of another Telematic Payment Card transmitting data
      2. In the back the card may have some terminals for:
2.1. Contacts for communication with another Telematic Payment Card or with a POS terminal
2.2. Contacts for Power, and charge the battery
2.3. Additionally, it may have some magnets to permit alignment while docking
2.4. In some cases, it may also have a micro-speaker to produce warning beeps
   3. In the building, embedded inside the card, there are several blocks that enable the implementation of the Telematic Payment Card core features. These blocks comprise, but not limited to:
3.1. Battery—the technology and type are such as to enable the Telematic Payment Card to be as slim and flexible as possible, this being known in the art
3.2. A memory, such as a Solid State, to store software and information received from the Central Control & Processing Unit, so that, as an example, the card-holder can keep a tight control of his payments and bank account status and movements
3.3. Two chips, or one single chip that, technology permitting, holds both the mobile networking information (as the one stored in SIM cards) and the banking information (as the EMV in use in Debit and Credit Cards)
3.4. A module to handle Input/Output, such as a touch-screen
3.5. A micro-processor to control the Telematic Payment Card and all its modules, possibly including a memory to store the controlling software
3.6. A communications module to handle the near-field change of data with other Telematic Payment Cards and POS terminals, and the communications with the mobile network and other networks

There are basically at least 3 ways in which payments can be made (although the invention supports other functionalities):

### Person to Person (P2P)—Cards Physically Present

Paying and payee cards are physically near allowing the exchange of banking data from payee to paying via any near-field communication. Paying party preferably needs availability of communications, such as mobile coverage, to access Central Control & Processing Unit network to clear the transaction. To be able to communicate and authenticate himself in the network, paying card needs battery charge.

Payee does not need battery and only needs mobile network access (and battery power, of course) if he wants to confirm the transaction independently.

### Person to Merchant (P2M)—Card Physically Present in a POS Terminal

The paying Telematic Payment Card is placed in or near payee POS Terminal, to make possible communication between them, and may use POS Terminal energy and network link to send authentication and transaction data. Paying card does not need mobile network to receive confirmation of payment as this card uses the POS Terminal link to confirm clearing or compensation (as done presently with current systems).

In addition, the Central Control & Processing Unit may check if there is unsent informative data (such as payment confirmations, bank information etc) for paying Telematic Payment Card and updates data in paying card accordingly.

Person to Person (P2P) or to Merchant (P2M)—Cards not Present. Paying Knows Bank Information (e.g. IBAN Code) of Payee

It is also possible to make payments in cases where both cards are not physically present or even when the payee has no Telematic Payment Card (but knows his bank account ID or any other ID that can be related to it, like IBAN). In these cases, the paying needs to have the identification of the payee bank account so that the Central Control & Processing Unit can make a bank transfer.

The paying Telematic Payment Card enters the IBAN (or other identification code) of payee (which can be a either a Person, a Merchant or even a Machine).

In this case, paying needs coverage (from mobile network as an example) to access Central Control & Processing Unit to clear the transaction. If the payee has a Telematic Payment Card with battery charge and network coverage, he will receive the payment confirmation in his card.

Payee only needs an account with IBAN (in countries that use this international code), or another bank account identification, and not necessarily a Card as presently described. This enormously increases acceptance of this innovation by reducing the requirements for usage.

Receiving Information from Financial or Commercial Institutions

Another very powerful functionality of the Telematic Payment Card is the ability to receive and manage information sent from banks, or from financial or even commercial institutions, via the Central Control & Processing Unit.

The information received can be of the following type:
Related to payments made or received via other Telematic Payment Cards
Related to banking movements made in the bank account linked to the Telematic Payment Card (direct debits, salary deposit, etc)
Related to movements or updates linked to any account or financial product the card-holder has with the bank or financial institution that issues the Telematic Payment Card (mortgage, savings account, funds etc)
From other commercial institutions that want to use this channel to inform or promote products or services. The message can be simply informative (marketing) but can also be discount vouchers to use in purchases, or even the management of loyalty programmes.
Electronic receipts, invoices, or tickets such as theatre or transport, paid or not with the Telematic Payment Card.

The level of communications received depends on the clearance and authorisation level the card-holder and issuer of the Telematic Payment Card have given for a given card.

The card-holder can also use the Telematic Payment Card to send messages to his card issuer (bank or financial institution) or to the manager of the card.

The Telematic Payment Card has the ability to keep a constant update of the status of the bank account linked to the card so that the card-holder may know exactly the money available in his account: all the financial transactions related to the bank account (point 1. and 2. Above) are preferably used to update this balance.

### Communications:

Communications between cards (in case of a P2P payment) can be made using any near field contact or contactless technology that allows the transmission of basic data such as the amount to transfer and the destination of the transfer (which can be using the IBAN, another well known account identification or a proprietary identification code).

This set of communications does not involve any sensitive or secret information, and as such the choice can fall on a technology that is compact and energy efficient, such as Near Field Communications, Bluetooth or physical contact with a proprietary protocol.

It is designed that, if the paying Telematic Payment Card has no battery power, and since it is the card that needs to be authenticated in both networks (mobile and central processing), it is able to take battery power from the payee card by binding them physically so that the power terminals touch themselves or bringing them close enough so that energy is exchanged by induction.

If the payment is a P2M to a merchant made via a POS terminal, communication is made by the appropriate contacts or by the close range technology. In this case, the Telematic Payment Card of the payee does not need battery and behaves as a normal Debit or Credit Card when inserted in a normal POS or brought near a contacless payment system. The only difference is that the new POS, that is connected to the Central Control & Processing Unit via their own fix or mobile line, can “lend” this link to the Telematic Payment Card of the payee so that he can receive information.

Payment to machines (P2Mx) can be either by near-field, by inserting a code (that identifies the destination of the payment) or by inserting the card in a slot.

Communication between the card and the Central Control & Processing Unit is made via any wireless method that allows an ultimate connection with the Central Control & Processing Unit. This can be a technology such as Wireless LAN but preferably is made via the mobile network using any protocol that allows secure data communication (such as 3G). The Telematic Payment Card is authenticated in the mobile network via the data in the SIM (as any normal mobile device) while the banking specific data, when needed, is authenticated via the data in the EMV part of the chip. As part of the data herein transmitted is highly confidential, to avoid the risk of fraud, preferably this data link is secure and allows a high level of authentication protocols. As GPRS/3G etc already uses SIM cards to authenticate mobile devices in the mobile network, using this technology seems to be the most indicated concerning security and universal acceptance. In addition it is the one most widely available due to their coverage worldwide.

One of the advantages of this invention is the fact that it does not need a 2nd Telematic Payment Card or a specific POS Terminal to work. By reducing the interdependency on other proprietary equipment, it maximises the probability of market acceptance.

Although it is much simpler to make payments and bank transfers using two Telematic Payment Cards or a specific POS Terminal, the payment or bank transfer can be done by inputting an ID that can be related to the bank account of the payee (e.g. IBAN), together with the amount to be paid.

Gradually implementing other value-added functionalities, adds value to the owner and issuer, increases the perceived value of the Telematic Payment Card, by the market.

To make payments and/or bank transfers the Telematic Payment Card preferably needs to be connected to a Central Control & Processing Unit. This Unit may be connected to an external clearing or compensation unit (if payment clearing or compensation is done by a third party), or/and directly to the issuing banks or other financial entities.

To give full mobility to the Telematic Payment Card this connection with the Central Control & Processing Unit is made preferably via the mobile network (which is, in addition, preferably a secure link). The Cards connect to the mobile network and the mobile operators forward these communications to the Central Control & Processing Unit via a secure link.

For security and efficiency reasons, the connection between the Central Control & Processing Unit and the financial entities or the clearing or compensation units is preferentially made via dedicated links.

The main functions of the Central Control & Processing Unit comprise:
to centralise the communications received from the Telematic Payment Cards via the mobile networks
to eventually centralise the communication with the financial institutions and clearing or compensation providers (or other institutions)
to eventually centralise the communications from the POS Terminal (based in merchants)
check the secure id of the Telematic Payment Card (stored in the SIM/EMV chip)
top-level evaluation of the data requests (Telematic Payment Card status, pending communications and warnings, credit limitations, fraud detection etc)

For payments in Merchants, to be as seamless as possible (i.e. without the need to introduce the amount to pay) and as similar as the present method, merchants preferably need a specific POS Terminal that accept Telematic Payment Cards. This POS Terminal should preferably also accept current payment cards based in the EMV chip or magnetic stripe.

The connection to an external clearing or compensation unit or to the financial institutions may not be necessary when the paying or/and payee have own account in the systems, in which case the invention also works as a financial institution, whereupon the paying or/and the payee both have accounts in this system and the processing and transaction is internal without involving any other financial institution or external clearing or compensation.

This invention can also be used to exchange information (besides payments) to and from the Telematic Payment Card. Any institution that wants to send or receive information (either regarding status of bank accounts, management of other financial products, information about new products, discount vouchers to be use in purchases etc) with a specific Telematic Payment Card or with a segment having Telematic Payment Cards, must preferably be connected to the Central Control & Processing Unit, which manages such communication. The Telematic Payment Card must preferably have the capacity to store and process the information received in an organized way, which is done using specific software installed in the Telematic Payment Card. This software can be differentiated for different issuers (i.e. dependant on the financial institution where the card-holder has his account) and should be stored in a memory unit that, for security reasons, should preferably not be easily accessible, namely for writing.

In a preferred embodiment, payments may be done using only one single Telematic Payment Card connected to the Central Control & Processing Unit, which may then be connected to a clearing or compensation unit, or directly to the financial institutions of the paying or payee. The payee party receives the payment as a normal bank transfer in his account.

In a preferred embodiment, financial institutions connected to the Central Control & Processing Unit may use the system to send information to their customers that have a Telematic Payment Card. This can be about transactions, about the status of their account or other products they have, or any type of advertising. If the user permits it, other institutions may send messages to a specific Telematic Payment Card.

In a preferred embodiment, the owner of a Telematic Payment Card can use his card to communicate to the financial institution that issued his card, or to any other institutions. He can use this to manage his bank account or any other product he may have with that institution.

In a preferred embodiment, the Telematic Payment Cards can receive vouchers, receipts, invoices, tickets or any other information from merchants. Voucher can be discounted directly when using the Telematic Payment Card or via their bank account and tickets can be used by presenting the Telematic Payment Card where it is stored, to a control device.

In a preferred embodiment, a the Telematic Payment Card can store information received from any source that is connected to the Central Control & Processing Unit, users can use their Telematic Payment Cards to keep track of their bank accounts, to manage their bank account or any other product they have with a financial institution, to manage vouchers and discounts, receipts and invoices, tickets etc

In a preferred embodiment, automatic machines can be prepared to accept payment from any Telematic Payment Card (P2Mx), contactless or with a slot.

### BRIEF DESCRIPTION OF DRAWINGS

The following figures provide preferred embodiments for illustrating the description and should not be seen as limiting the scope of invention.

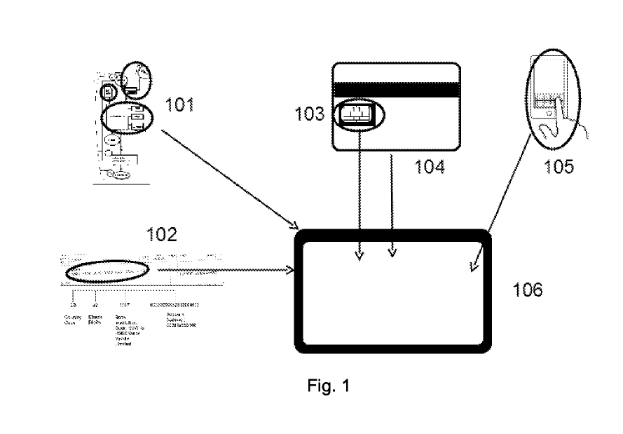

FIG. 1 shows the concept behind the invention of the Telematic Payment Card, namely its conceptual building blocks, where:
(101) represents the mobile telecommunication modules relevant to this invention, namely the data communication parts, comprising the antenna, processor and SIM parts
(102) represents a bank account identification method commonly used in the markets presently. This could be the IBAN code or any other method compatible with the invention and banks using the system such as the ones used for card payments
(103) represents the EMV chip present in modern payment cards, and that securely and uniquely identify the card and related information, such as the PIN
(104) represents the look and feel of common payment cards such as credit or debit cards.
(105) represents a method for entering data and commands to a device. This could be a touch screen, a keyboard or a series of keys.
(106) represents the Telematic Payment Card

The Telematic Payment Card preferably has the look and feel as close as possible of an existing credit or debit card, in terms of size and shape (104). It more preferably includes the card secure information that enables the card to be uniquely identified in terms of bank account or financial information (103) (that, presently is embedded in EMV chips). It also preferably has basic technology from mobile data communications, namely the SIM chip that has unique information enabling the secure identification of the card in a mobile network (101). From the mobile technology, it also has a basic module to send, receive and process data in the mobile environment or other communications network (101). It more preferably has embedded an ID that links a specific Telematic Payment Card to a bank account (102) (this can be the IBAN or any other similar id). Finally, it has a method of inputting and outputting information (105) (via a touch screen).

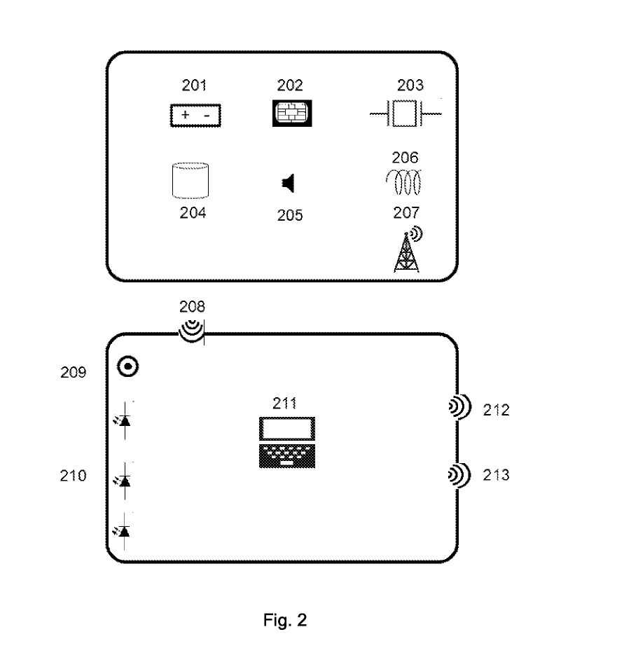

FIG. 2 identifies the core blocks that preferably make up the invention. On top the internal building parts, and on the bottom the external parts and buttons, where:
(201) represents the battery module.
(202) represents security chip like the SIM for communications or the EMV for banking, preferably residing in the same module.
(203) represents the processor module, including the memory to store the management software, that should preferable, for security reasons, be read only.
(204) represents the memory module for storing information received in the Telematic Payment Card.
(205) represents a possible sound generating device, that will help communicate with the card user.
(206) represents the near-field communication, that can be based in RFID or any other technology, that will allow the Telematic Payment Card to communicate with other cards or with any other terminal.
(207) represents the remote mobile communication module, that will preferably allowed the Telematic Payment Card to communicate with the Central Control & Processing Unit.
(208) represents the terminal for charging the device. These can be physical terminal, for contact, or hidden ones for inductive charging.
(209) represents a button that can preferably be used for power on/off, or to put the device on hold.
(210) represents a group or informative leds, that will preferably inform the card user about the status of the card or the communications.
(211) represents the input/output device, that can be a touch screen or any device.
(212) represents a possible near-field communication antenna or a terminal for contact communications.
(213) represents a possible remote communication antenna for a probably mobile communications preferably based in GSM/3G/4G.

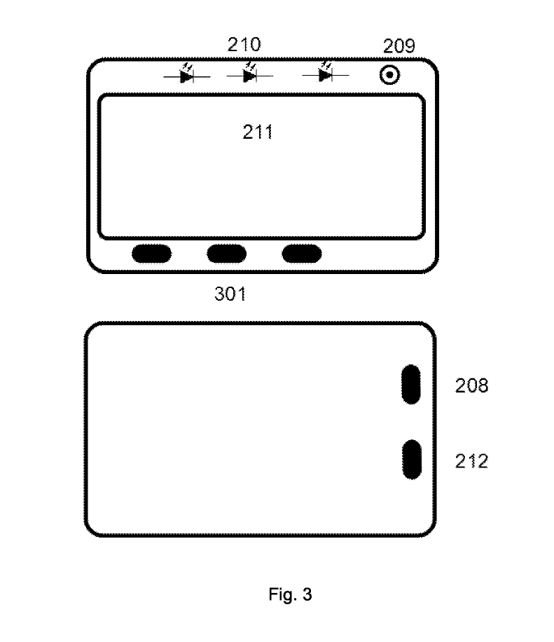

FIG. 3 shows the parts, buttons and indicators that a card user preferably sees when handling the Telematic Payment Card. On top the front side, and on the bottom the back side, where:
(301) represents a series of hard buttons (in opposition to virtual buttons that can be touched via the touchscreen) that could be optionally be part of the Telematic Payment Card as to help the user navigating in the menus or managing the card.

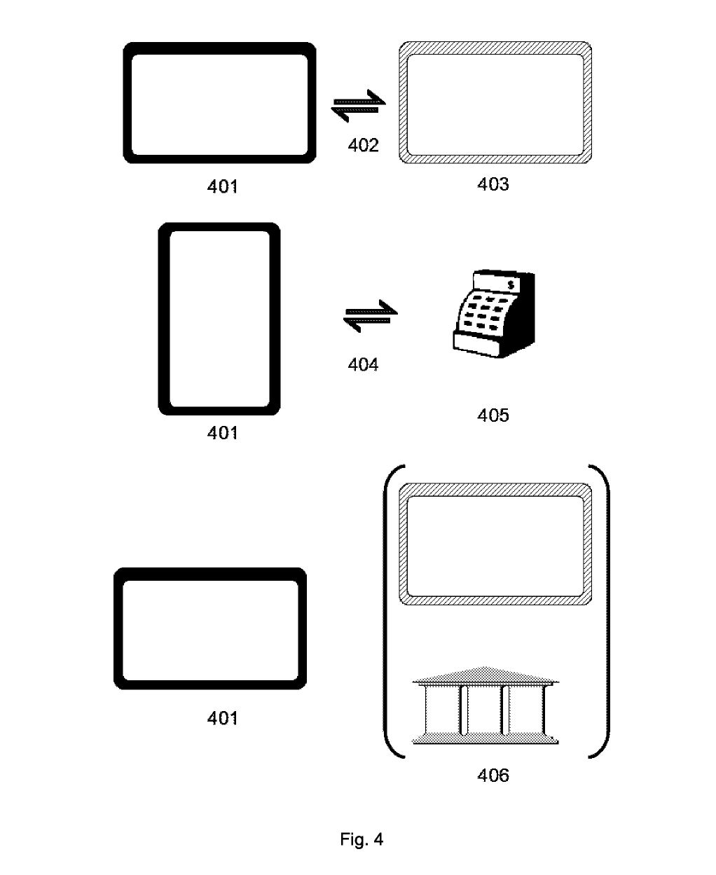

FIG. 4 shows the 3 preferred methods for making payments using the Telematic Payment Card, namely the Person-To-Person with both cards present and operational, Person-To-Merchant or Person-To-Machine with the card and a POS nearby or physically in contact, and the payment from a Person To either another Person to a Merchant or to a Machine, but where paying and payee are not physically present, but where the paying know the ID of the payee (IBAN or another similar ID identifying the destination of the transaction), where:
(401) represents the paying Telematic Payment Card
(402) represents the contactless link that the paying Telematic Payment Card (401) uses to fetch payee (403) banking data
(403) represents the payee Telematic Payment Card that is in physical presence of the paying Telematic Payment Card (401)
(404) represents the communicating link established between the POS of the merchant (405) and the paying Telematic Payment Card (401). This link can be either with physical contact or contactless by near-field communication
(405) represents the merchant POS, or payee
(406) represents a payee that is not physically near the paying Telematic Payment Card (401). The payee can be another Telematic Payment Card, or a person, machine or merchant identified with a bank account ID, that the payee uses to make the payment

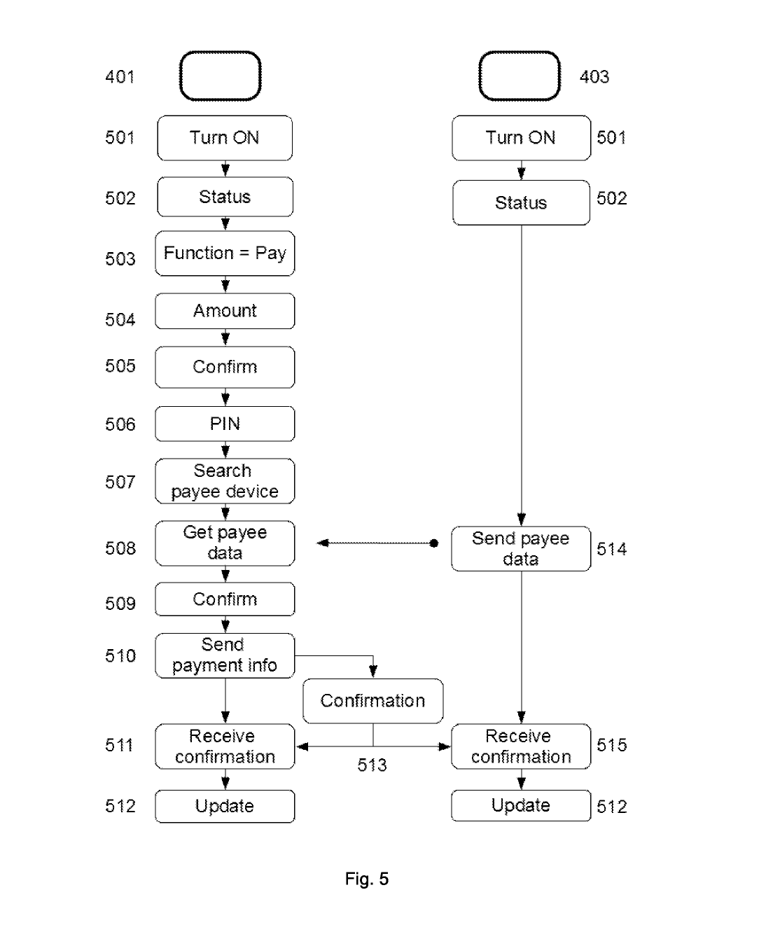

FIG. 5 exemplifies the process of making a payment Person-To-Person as described in the first part of the chapter “SPECIFICATION” and in top part of FIG. 4 (401), (402), (403), where:
(501) represents the card being turned on.
(502) represents the Telematic Payment Card (401) updating the screen with the available balance in the bank account.
(503) represents the “Pay” function being selected.
(504) represents the amount to be paid being entered.
(505) represents the user confirming the amount entered in the device.
(506) represents the security PIN being entered and being checked by the Telematic Payment Card.
(507) represents the paying Telematic Payment Card searching for the payee device (403).
(508) represents the Telematic Payment Card (401) reading the payee data using a near-field communication system such as RFID.
(509) represents the payee data being confirmed by the user.
(510) represents the Telematic Payment Card (401) sending the payment information (amount, payee information data and paying information data) being sent to the Central Control & Processing Unit for confirmations.
(511) represents the Telematic Payment Card (401) receiving the confirmation from the Central Control & Processing Unit that the payment has been accepted and was processed.
(512) represents Telematic Payment Cards (401) and (403) updating the available balance in the bank account, and adding the transaction in the memory.
(513) represents the Central Control & Processing Unit receiving the payment information and processing it, communicating with the paying bank (906) or the clearing or compensation units if necessary.
(514) represents the payee Telematic Payment Card (403) sending the data related with the bank account so as to process the payment, using a near-field communication system such as RFID.
(515) represents the Telematic Payment Card (403) receiving a communication from the Central Control & Processing Unit informing that a payment was processed where the bank account linked to this payee card (905) was credited with a certain amount.

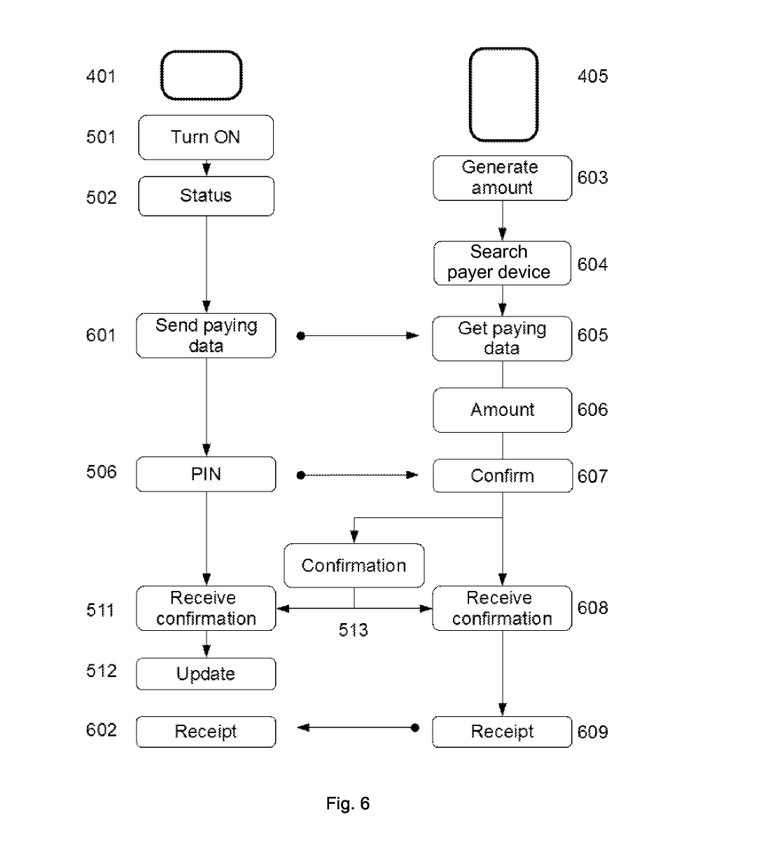

FIG. 6 exemplifies the process of making a payment Person-To-Merchant as described in the second part of the “description of invention”, where:
(601) represents the Telematic Payment Card of the paying (401) sending his payment information via a near-field communication system such as RFID.
(602) represents the Telematic Payment Card (401) receiving an electronic format of the receipt of the purchase made, and storing it in the card's memory.
(603) represents the POS (405) calculating or generating the amount to be paid by the paying party.
(604) represents the POS device (405) scanning for a Telematic Payment Card using near-field communication.
(605) represents the POS (405) reading the paying data so as to process the payment.
(606) represents the POS (405) displaying the amount to be paid.
(607) represents the confirmation received from the paying Telematic Payment Card (401) that the amount was accepted and that the PIN entered by the user was correct and the POS sending the payment information (amount, payee information data and paying information data) being sent to the Central Control & Processing Unit for confirmations.
(608) represents the POS (405) receiving the confirmation that the payment was accepted and processed.
(609) represents the POS (405) system generating and sending an electronic format of the receipt or invoice, in case the system has such a capability.

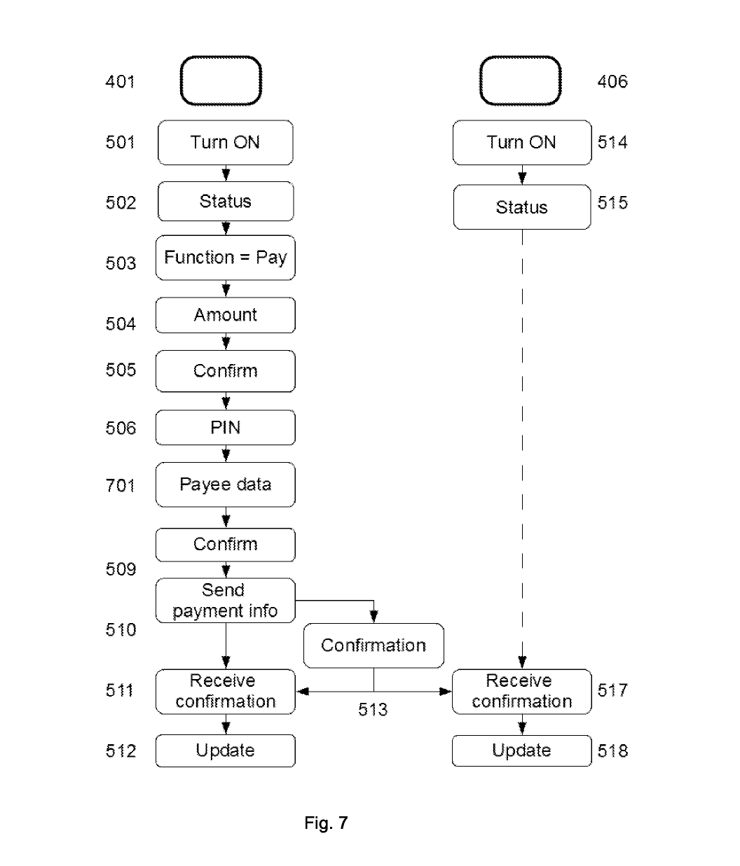

FIG. 7 exemplifies the process of making a payment Person-To-Person, to Merchant or to Machine, when the payee party is not present, as described in the point 5. of the first part of the chapter “Description of the Invention” and in the bottom part of FIG. 4 (401) and (406), and where the payee (406) can be either another Telematic Payment Card or a bank account, and where:
(701) represents the user of the paying Telematic Payment Card entering the ID of the destination bank account manually (can be via the IBAN, via the name of the person or any other method) or to retrieve that ID from the memory of the card.

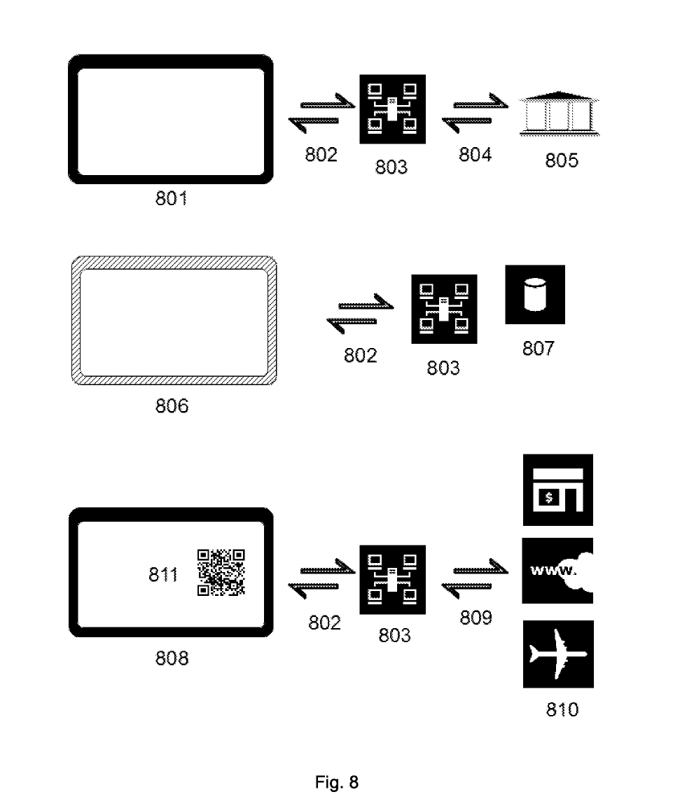

FIG. 8 exemplifies non-payment options permitted by the Telematic Payment Card such has managing and keeping update of the bank account linked to the card (801) as described in third part of the chapter “Description of the Invention” and in points 1., 2. and 3. of the chapter “Receiving information from financial or commercial institutions” and in top of FIG. 8. It also exemplifies the use of the Telematic Payment Card as a pre-paid card (806) for people without bank account, exemplified in the middle of FIG. 8. Another example of an additional service offered by the invention is the usage of the card to receive promotional information and vouchers as in point 4. of the chapter “Receiving information from financial or commercial institutions” and in the bottom of FIG. 8.
(801) represents the Telematic Payment Card that will receive, send and manage information related with the bank account linked to this card
(802) represents the communication link between the Telematic Payment Card (801) and the Central Control & Processing Unit, that will preferably be via the mobile network
(803) represents the Central Control & Processing Unit that will preferably centralise, coordinate and process all communication from an to the Telematic Payment Cards
(804) represents the communication link between the Central Control & Processing Unit the bank wanting to communicate with the Telematic Payment Card (801), and that will preferably be via fixed secure and dedicated link
(805) represents the bank that wants to communicate with or receive a communication from the Telematic Payment Card (801)
(806) represents the Telematic Payment Card that, not having a bank account linked to it, may have a prepaid amount that may be used for payments
(807) represents a possible database and system where the prepaid accounts will reside. This system will be managed by the Central Control & Processing Unit (803) linked to the Telematic Payment Card (806)
(808) represents the Telematic Payment Card that will eventually receive an electronic document such as an invoice, receipt, voucher, mail, ticket or any other.
(809) represents the communication link between the entity that wants to communicate with the card (808) and the Central Control & Processing Unit (803)
(810) represents the entity, commercial, governmental or other, that wants to send the electronic document to the Telematic Payment Card (808).
(811) represents the electronic document received by the Telematic Payment Card (808). This document can be in text, image, electronic, in 2D barcode or any format compatible with the system

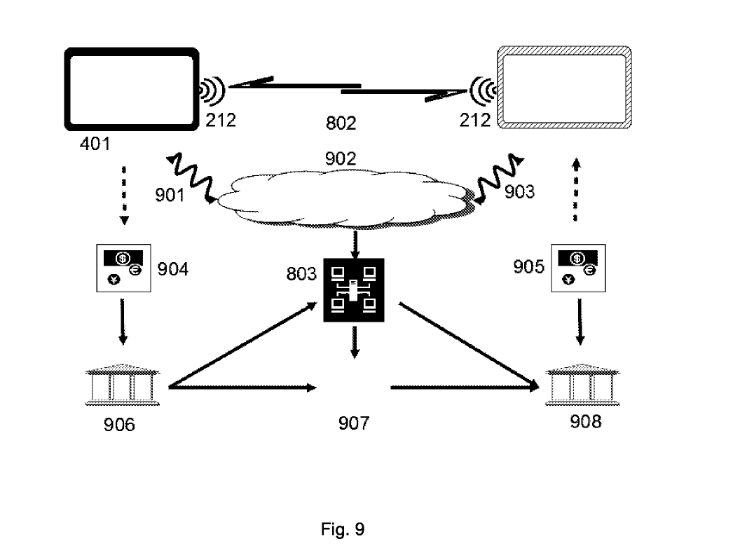

FIG. 9 shows the preferred infrastructure used when making a Person-To-Person payment either physically present or remotely (using an ID that identifies the destination of the payment, like IBAN), where:
(901) represents the connection between the paying Telematic Payment Card (401) and the remote communication network, that will preferably be a mobile network
(902) represents the remote, long distance communication network, that will preferably be a mobile based network, like GSM, 3G or 4G
(903) represents represents the possible connection between the payee Telematic Payment Card (403) and the remote communication network, that will preferably be a mobile network
(904) represents the bank account linked with the paying Telematic Payment Card (401), and where the payment will be debited
(905) represents the bank account linked with the payee Telematic Payment Card (403) and where the payment will be credited
(906) represents the bank linked to the paying account (904)
(907) represents the clearing or compensation unit, that will eventually process the payment and will make the transfer of funds between the involved banks. This will not be necessary if (906) and (908) are the same bank or if they have a specific agreement
(908) represents the bank linked to the payee account (905)

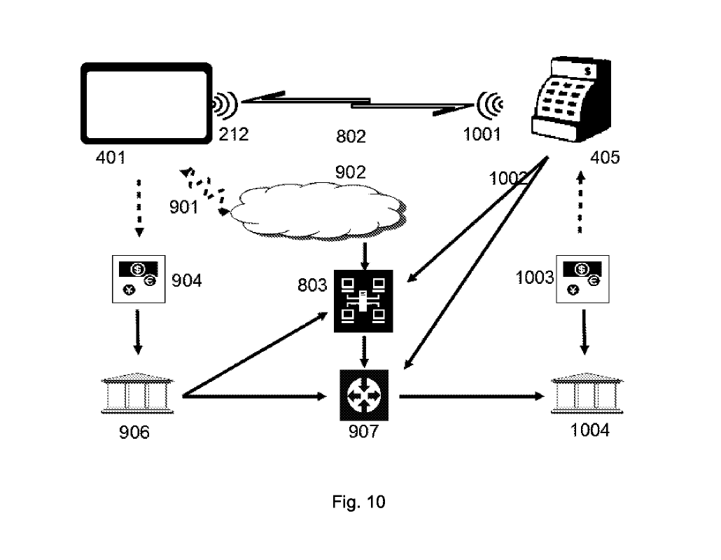

FIG. 10 shows the preferred infrastructure used when making a Person-To-Merchant payment using a Point Of Sale device (405). In this case the paying Telematic Payment Card (401) does not need to have connection to communications (like mobile network) as the POS must usually be linked to the Central Control & Processing Unit and to the clearing or compensation (907) via (1002) to process the payment, and thus the card can use this secure link to receive information related to the transaction and to the bank account linked to his card. In this figure:
(1001) represents a possible near-field communication device or a contact based device, that will enable the POS (405) to retrieve the banking data from the paying Telematic Payment Card (401), using a method and technologies similar to what is being employed at the moment.
(1002) represents the link between the POS (405) and the Central Control & Processing Unit and/or to the clearing or compensation units (907). This link should preferably be fixed and dedicated, for security and reliability purposes.
(1003) represents the bank account linked to the payee merchant owning the POS (405), and where the payment will be credited
(1004) represents the bank linked to the payee or merchant account (1003)

### MODES FOR CARRYING OUT THE INVENTION

To make a payment using the Telematic Payment Card in the presence of another Telematic Payment Card comprises:
1. In case the card is off (no power), or in stand-by (input-output disabled), the paying party presses “Power” in his card to make it go into active mode, and afterwards selects the “Pay” key. The payee may do so if he wishes to control the payment. Paying party preferably needs to check in the indicators if he has network coverage (may be mobile) to proceed with the payment. In case he does not have, payment should preferably only be processed when he enters network coverage.
2. Paying party introduces the amount to pay, and “Enter” when finished (or “Correct” to start again, or “Back” to correct one digit)
3. He may be prompted to enter a secret PIN. Both cards go into close range so that paying Telematic Payment Card can read payee's bank account ID (may be in the form of IBAN or anotherID) stored in his Telematic Payment Card and vice-versa. The cards show an indication (via a led or in the screen or with an audio beep) that the cards are connected. The amount and the formal identification of each party is exchanged. This information is preferably transmitted via a close range communication. When this is done, the screens of both Telematic Payment Cards preferably show the amount and the formal identification of the other party. Paying party preferably confirms the transaction by pressing the “Yes” key.
4. Data is sent from the paying Telematic Payment Card via the network, to the Central Control & Processing Unit. This unit checks all authentications and security clearances, and proceeds to send the transaction request either to the financial institutions involved or to a clearing or compensation entity. When the Central Control & Processing Unit receives confirmation of the transaction, it sends this confirmation to both paying and payee Telematic Payment Cards via the network.
5. In case the payee Telematic Payment Card is not present (or the payee does not have a card), the paying manually enter the payee ID that identifies his bank account. The payee will receive a confirmation in case he has a card and this is connected to the network.

To make a payment with the Telematic Payment Card in a Merchant with a POS Terminal is even simpler, as the amount to pay is calculated by the cash register or the merchant (just as it is now with the current POS) and sent to the Telematic Payment Card.
1. Paying party does not need network coverage or battery to proceed or confirm the payment. In case the card is off (no power), or in stand-by (input-output disabled), the customer with the Telematic Payment Card presses “Power” in his card to make it go into active mode. If the card is out of battery, he preferably has to do this after inserting the Telematic Payment Card in the POS Terminal (from where the card gets its power).
2. The merchant, using the same procedure as with any other POS, introduces the amount to pay, which shows up, together with the identification of the merchant, in the Telematic Payment Card monitor. The customer confirms by pressing a predefined key.
3. The customer's Telematic Payment Card may prompt him to introduce a security PIN code. After which the POS Terminal communicates, directly or via a clearing or compensation unit, with the Central Control & Processing Unit (preferably via a dedicated secure link) transmitting the authentication data and after the transaction data (amount and accounts IDs). If all data is correct, and the card has passed the security tests, the Central Control & Processing Unit sends the transaction information for Clearing/Compensation after which it sends the confirmation of the transaction to both the POS Terminal and the Telematic Payment Card.
4. The customer may remove his card and, if he has battery and access to the network (e.g. mobile), he receives another communication from the Central Control & Processing Unit with his most recent balance.

To use the Telematic Payment Card for other functions, like managing the card, receiving information from his card issuer or from other financial institutions, or receiving or using things like vouchers, receipts, invoices or tickets, depends on the software installed on the card, according to the invention and as referred above. Preferably, this should be as simple as possible, to allow the card to be used by a wider range of people including those not tech-savvy.

To use the Telematic Payment Card to keep track of the bank account linked to the card, and to receive constant information about any transaction being made in that account is very simple and the card-holder does not need to perform any special action:
1. Card needs, at least intermittently, to have network coverage and battery power and Telematic Payment Card needs to be operational, e.g. “on” or in “stand-by” mode.
2. The issuer of the Telematic Payment Card, either a bank or any other financial institution that holds the bank account linked to the card, will preferably send any updates related to the bank account to the Central Control & Processing Unit. This unit will then forward that information, via the communications network (e.g. mobile), to the concerned Telematic Payment Card.
3. The card will receive this information (if conditions in point 1. are met, otherwise the information will only be sent once the card gets into network coverage) and an indicator will preferably blink to inform that an update has arrived.
4. The card-holder will then turn the card “on” and will read or/and send to an archive the information.
5. The card will update the total account balance according to the information received (will add any transaction received or subtract any payment made).
6. Besides information related to payments from other Telematic Payment Cards, the card-holder can have a constant update of his bank account, knowing exactly how much money he has available, and will also preferably know every time a movement is performed in his account (such as mortgage payment, receiving salary, direct debit payment etc etc).

The invention is of course not in any way restricted to the embodiments described and a person with ordinary skill in the art will foresee many possibilities to modifications thereof without departing from the basic idea of the invention as defined in the appended claims. The described embodiments are obviously combinable. The following claims also set out further particular embodiments of the invention.

1. An electronic card for payments (106) comprising:
a) card enclosure (104);
b) first chip for communication identification and authentication (101);
c) second chip for secure payment identification and authentication (102, 103);
d) input module for inputting payment amounts and other information and confirming transactions (211);
e) display module for displaying payment amounts, transaction confirmations and other information (211);
wherein the electronic card is configured to:
a) connect wirelessly with a second party;
b)transfer amount to second party, whether directly or whether through a central processing server.

2. The electronic card for payments according to claim 1 wherein said second party is a second electronic card for payments (106).

3. The electronic card for payments according to claim 1 wherein said second party is a merchant POS unit (405).

4. The electronic card for payments according to claim 1 wherein the electronic card (106) is configured to issue and/or receive confirmations of said payments.

5. An electronic card for accessing and managing a bank account according to claim 1.

6. The electronic card for payments according to claim 1 wherein the first chip for communication identification and authentication (101) is a SIM chip for wireless mobile data communication.

7. The electronic card for payments according to claim 1 wherein the second chip for secure payment authentication (103) is a EMV chip for secure card-holder identification and payment processing.

8. The electronic card for payments according to claim 1 wherein the input and display module comprises a touchscreen (211).

9. The electronic card for payments according to claim 1 further comprising a data processing module for executing software programs and processing data.

10. The electronic card for payments according to claim 1 further comprising a memory module for storing software programs for being executed by the electronic data processing module.

11. The electronic card for payments according to claim 1 wherein the first chip for communication identification and authentication and the second chip for secure payment authentication are comprised in the same physical chip.

12. The electronic card for payments according to claim 1 further comprising a first communications module which comprises said first chip for communication identification and authentication.

13. The electronic card for payments according to claim 12 wherein said first communications module is for mobile phone data communications, in particular GSM/CDMA/UMTS/4G.

14. The electronic card for payments according to claim 12 wherein it is configured to use said first communications module for payment communications.

15. The electronic card for payments according to claim 1 further comprising a second communications module, for a shorter communication range than that of the first communications module, if present.

16. The electronic card for payments according to claim 15 wherein said second communications module is for near-field communications, in particular RFID.

17. The electronic card for payments according to claim 15 wherein it is configured to use said second communications module for payment communications.

18. The electronic card for payments according to claim 1 further configured to require a personal authorisation confirmation for processing a payment.

19. The electronic card for payments according to claim 18 wherein said personal authorisation confirmation is a PIN confirmation.

20. An electronic payment system comprising an electronic card for payments according to claim 1.

21. A method for operating an electronic card for payments to a second electronic card, both as in claim 1, comprising the steps of:
a) activating payment function (503);
b) receiving amount indication (504) from the card user;
c) optionally receiving payment confirmation (505) from the card user;
d) receiving payee data from payee device (507, 508);
e) optionally receiving payee confirmation (509) from the card user;
f) sending payment data to central processing server (510);
g) receiving payment confirmation from central processing server (513);
h) optionally displaying payment confirmation to card user.

22. The method for operating an electronic card according to claim 21, comprising the steps of:
a) activating payment function (503);
b) receiving amount indication (504) from the card user;
c) optionally receiving payment confirmation (505) from the card user;
d) receiving payment authorization (506) from the card user;
e) receiving payee data (701) from the card user;
f) optionally receiving payee confirmation (509) from the card user;
g) sending payment data to central processing server (510);
h) receiving payment confirmation from central processing server (511, 513);
i) optionally displaying payment confirmation to card user.

23. The method according to claim 21 for operating a system comprising said electronic card for payments, comprising the steps of:
a) searching for a payer electronic card (604);
b) receiving payment data from a payer electronic card (605);
c) optionally displaying the amount and/or payee (606);
d) receiving authorization of payment and sending payment data to central processing server (607);
e) receiving payment confirmation from central processing server (608);
f) optionally sending a payment receipt (609) to the card user.

24. A computer program comprising program code instructions for carrying out each of the steps of the method according to claim 21, when said program code instructions are executed in a data processing system.

25. A computer readable medium comprising the computer program according to claim 24.
